(19) United States
(12) Patent Application Publication
(10) Pub. No.: US 2008/0254941 A1
(43) Pub. Date: Oct. 16, 2008

(54) Controlling the operating states of a torque converter clutch in an automatic transmission

(76) Inventors: Jeffery Scott, Kalamazoo, MI (US); Joseph J. Gallo, Fraser, MI (US); Douglas R. Cecil, Westland, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/786,296

(22) Filed: Apr. 11, 2007

(51) Int. Cl. F16H 61/14; G06F 19/00

(52) U.S. Cl. 477/169; 701/67

(57) ABSTRACT

A method for controlling a torque converter clutch in an automatic transmission of a vehicle that includes an engine, an accelerator pedal and wheels, the converter clutch alternately connecting and disconnecting the engine and transmission when the clutch is engaged and disengaged. The method includes determining that the vehicle is either ascending a grade or operating in a loaded condition, determining that the clutch is engaged, determining whether the vehicle is operating in a curve, preventing disengagement of the clutch if the vehicle is either ascending a grade or operating in a loaded condition and the vehicle is operating in a curve, and allowing disengagement of the clutch if the vehicle is neither ascending a grade nor operating in a loaded condition.

### BACKGROUND OF THE INVENTION

1. Field of the Invention

The preferred embodiment relates generally to an automatic transmission for automotive vehicles and, in particular, to controlling the lockup clutch of a torque converter for an automatic transmission.

2. Description of the Prior Art

An automotive vehicle includes an internal combustion engine, which converts fuel into rotational energy having torque and speed characteristics, and a powertrain, which transmits rotational energy from the engine to the vehicle's wheels. A transmission, which produces step changes in speed ratio, includes a hydrodynamic torque converter, which transmits engine torque to an input member of a gearbox.

The torque converter includes a toroidal chamber containing fluid, a bladed impeller coupled for rotation to the engine crankshaft, a turbine coupled for rotation to the input shaft, a stator for redirecting fluid flow from the turbine to the impeller, and a lock-up or bypass clutch for locking the impeller and turbine such that they rotate at the same speed.

The torque converter clutch can be controlled to increase the operating efficiency and performance of the powertrain and to reduce the temperature of the fluid in the torque converter. In the absence of extraordinary operating conditions, the converter clutch is engaged when a vehicle transmission is operating in its highest gear. Short term, repeated engagement and disengagement of the converter clutch increases the temperature of the clutch and fluid in the torque converter and produced undesired noise, vibration and harshness in the vehicle's powertrain issues.

When a motor vehicle tows a load up a grade with the engine throttle open, i.e., with the throttle position high, the torque converter clutch is engaged to improve efficiency and assist with powertrain cooling. As the vehicle approaches a curve on the grade, the driver would normally tip-out, i.e., reduce displacement of the engine throttle and the demanded engine output torque by releasing the accelerator pedal. This would cause the torque converter clutch to disengage and the transmission control to produce an upshift, i.e., change to a higher gear than the current gear. After the vehicle has exited the curve, the operator would again tip-in, i.e., increase displacement of the engine throttle and the demanded engine output torque by depressing the accelerator pedal, which action would probably cause a down shift and eventually a re-engagement of the torque converter clutch. When the torque converter clutch repeatedly disengages under these operating conditions, heat is generated and the additional gear shifts can have detrimental effects on the vehicle's noise, vibration and harshness (NVH).

### SUMMARY OF THE INVENTION

A method for controlling a torque converter clutch in an automatic transmission of a vehicle applies to a vehicle that includes an engine, an accelerator pedal and wheels, the converter clutch alternately connecting and disconnecting the engine and transmission when the clutch is engaged and disengaged. The method includes determining that the vehicle is either ascending a grade or operating in a loaded condition, determining that the clutch is engaged, determining whether the vehicle is operating in a curve, preventing disengagement of the clutch if the vehicle is either ascending a grade or operating in a loaded condition and the vehicle is operating in a curve, and allowing disengagement of the clutch if the vehicle is neither ascending a grade nor operating in a loaded condition.

A system for controlling the torque converter clutch includes a torque converter clutch alternately connecting and disconnecting the engine and transmission when the clutch is engaged and disengaged, respectively, an accelerator pedal for at least partially controlling operation of the engine, an accelerator pedal sensor producing a signal representing a position of the accelerator pedal, and a controller in communication with the transmission, the engine, the clutch, and the accelerator pedal sensor, the controller being configured to determine that the vehicle is either ascending a grade or operating in a loaded condition, determine that the clutch is engaged, determine whether the vehicle is operating in a curve, prevent disengagement of the clutch if the vehicle is either ascending a grade or operating in a loaded condition and the vehicle is operating in a curve, and allow disengagement of the clutch if the vehicle

When the torque converter clutch is engaged because the system detects a high vehicle load or a large grade disengaging the converter clutch or allowing an upshift for a tip-out is delayed. The delay provides time to detect operation of the vehicle on a curve and to activate the shift inhibit control logic.

Before activating the curve inhibit, this control requires the system either to activate engine braking currently or to determine that the reason for the converter clutch being engaged is because of high vehicle load.

The control detects operation on a curve using the wheel speed sensors available in vehicles equipped as such. It does not require lateral acceleration speed sensors. The control prevents cycling of the converter clutch between engaged and disengaged states.

The control avoids NVH issues by inhibiting converter clutch disengagement and back-out upshifts while towing up hills and around curves, condition in which NVH is most critical. This improve drivability and powertrain cooling such that auxiliary cooling packs to cool the transmission fluid while the vehicle is towing a load are not required.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

These and other advantages will become readily apparent to those skilled in the art from the following detailed description of a preferred embodiment when considered in the light of the accompanying drawings in which:

FIG. 1 is a schematic diagram of a motor vehicle powertrain;

FIG. 2 is schematic diagram showing sensors, control algorithms executed by the PCM, and powertrain components controlled by the PCM;

FIG. 3 is a logic flow diagram illustrating a shift scheduling control algorithm; and

FIG. 4 is a logic flow diagram illustrating a converter clutch scheduling algorithm.

### DESCRIPTION OF THE PREFERRED EMBODIMENT

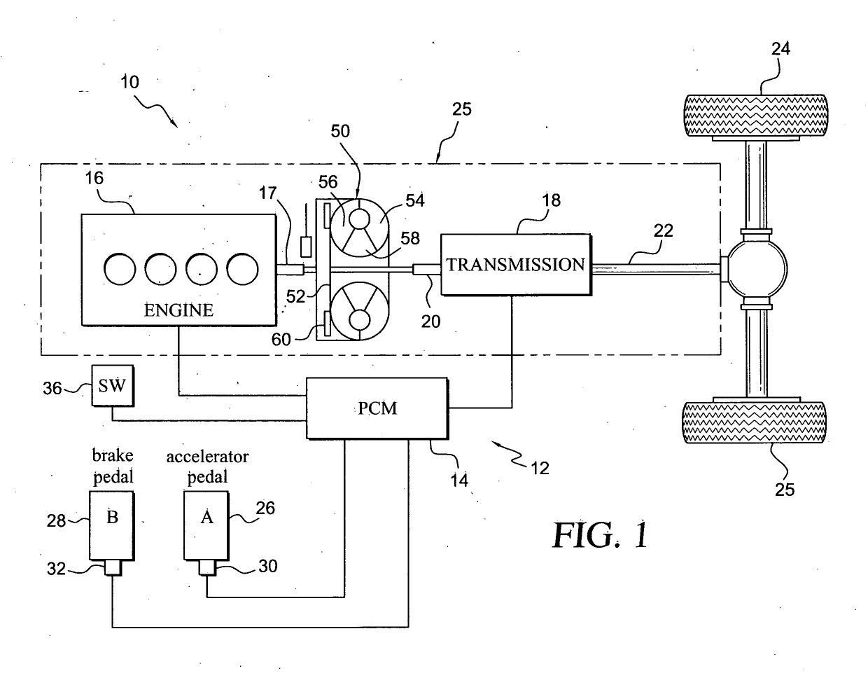

In FIG. 1, the powertrain of vehicle 10 is controlled by a system 12, which includes a controller or powertrain control module (PCM) 14, which includes a electronic microprocessor, electronic memory, and communication ports communicating through a controller area network (CAN) with an engine 16 and an automatic transmission 18. The PCM 14 is connected directly to the engine 16 and the transmission 18; however, other configurations are possible. In one such configuration, the engine 16 and the transmission 18 have separate controllers, for example, an engine control module (ECM) and a transmission control module (TCM), which communicate directly with each other. A vehicle system controller (VSC) could also be used to communicate with a TCM and an ECM, for example, on the CAN. Similarly, a controller, such as the PCM 14, can be used in vehicles having different configurations from the one illustrated in FIG. 1, such as hybrid electric vehicles (HEV), and fuel cell vehicles.

The vehicle 10 also includes a transmission input shaft 20, which connects the engine crankshaft 17 to the transmission 18, and a transmission output shaft 22, which connects the transmission 18 to the vehicle wheels 24. Collectively, the engine 16, transmission 18, transmission converter clutch 50, and shafts 17, 20, 22 comprise the powertrain.

An accelerator pedal 26 and a brake pedal 28 are operated by a vehicle operator to selectively increase and decrease the speed of the vehicle 10. The accelerator pedal 26 includes an accelerator pedal sensor 30, which communicates with the PCM 14. Similarly, the brake pedal 28 includes a first brake pedal sensor, or brake position sensor 32.

Accessible to the PCM 14 and stored in the electronic memory are computer programs that control at least two different shift modes. The first shift mode is a normal mode, which may be used when the vehicle 10 is not towing or hauling heavy cargo. The second shift mode, or grade/tow mode, may be used when the vehicle 10 is towing or hauling heavy cargo. The PCM 14 is programmed with a number of shift points for each of the shift modes. The shift points include upshift points for defining when the transmission 18 is allowed to shift to a higher gear, and downshift points for defining when the transmission 18 is allowed to shift to a lower gear. Each shift point is programmed into the PCM 14 and is defined by the vehicle speed and accelerator pedal position. The PCM 14 signals the transmission 18 to shift to a higher or lower gear, when a shift point is reached.

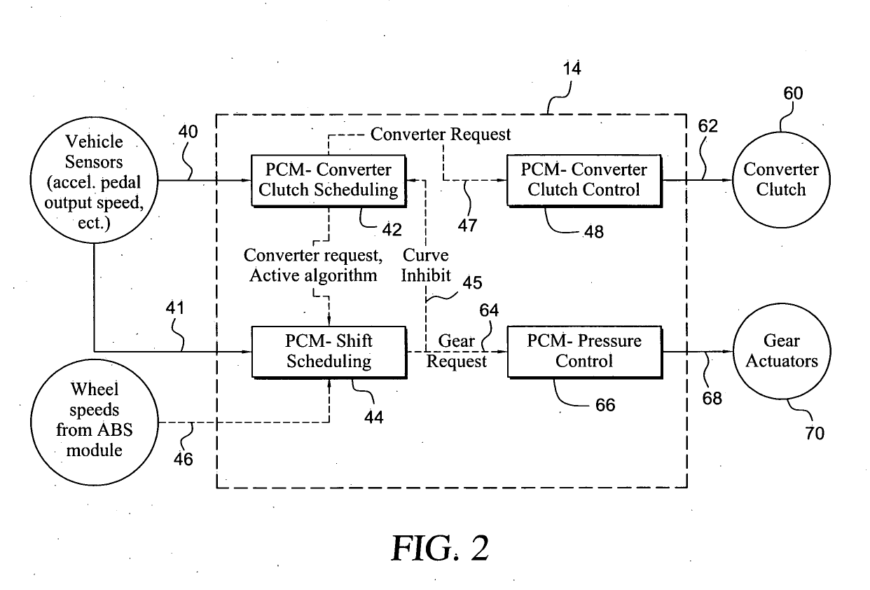

FIG. 2 schematically illustrates the organization of the PCM 14. A signal representing the speed of the transmission output shaft 22 and signals produced by sensors 30 and 32, representing the degree to which the accelerator pedal and brake pedal are depressed, are input at 40, 41 to a converter clutch scheduling control algorithm 42 and a gear shift scheduling algorithm 44 located in the PCM 14.

Signals produced by sensors, representing the speeds of the wheels 24, 25 at each lateral side of the vehicle 10, are input at 46 to the gear shift scheduling algorithm 44. Upon executing the gear shift scheduling algorithm 44 using the current wheel speed signals, the PCM 14 determines whether the vehicle is operating in a curve. If the vehicle 10 is operating in a curve, a signal 45 indicating that the curve inhibit control is activated is supplied to the converter clutch scheduling routine 42. Upon executing the converter clutch scheduling control algorithm 42 a signal 47 representing a request to engage or disengage the converter clutch is sent to a converter clutch control algorithm 48, which is accessible to the PCM 14.

The transmission 18 includes a hydrodynamic torque converter 50, which transmits engine torque to transmission input shaft 20. The torque converter 50 includes a toroidal chamber 52 containing fluid, a bladed impeller 54 coupled for rotation to the engine crankshaft 17, a bladed turbine 56 coupled for rotation to the input shaft 20, a stator 58 for redirecting fluid flow from the turbine to the impeller, and a lock-up or bypass clutch 60 for mechanically connecting the impeller and turbine so that they rotate at the same speed and disconnecting the impeller and turbine so that they rotate mutually independently.

The converter clutch control algorithm 48 produces output commands 62, which cause an actuator of the converter clutch 60 alternately to engage and disengage the converter clutch. When the gear shift scheduling algorithm 44 produces a gear change request 64, a pressure control algorithm 66 responds to the request by issuing a command signal 68 to clutch and band brake solenoids 70, which hydraulically actuate respective friction control elements of the transmission 18, thereby causing upshifts and downshifts in response to the commands 68.

The shift scheduling algorithm 44 includes a grade/tow algorithm, which is executed by the PCM 14 when the control system detects a high vehicle load or a large grade. The PCM 14 detects the presence of a high vehicle tow load or operation of the vehicle on a steep grade when, for the current position of the accelerator pedal 26, the current vehicle acceleration is lower than would be expected if the vehicle were unloaded or not operating on a grade. A look-up table containing magnitudes of vehicle acceleration corresponding to the current gear and accelerator pedal position can be used to determine the expected range of vehicle acceleration, which can then be compared to the current vehicle acceleration to determine whether current vehicle acceleration is abnormally low.

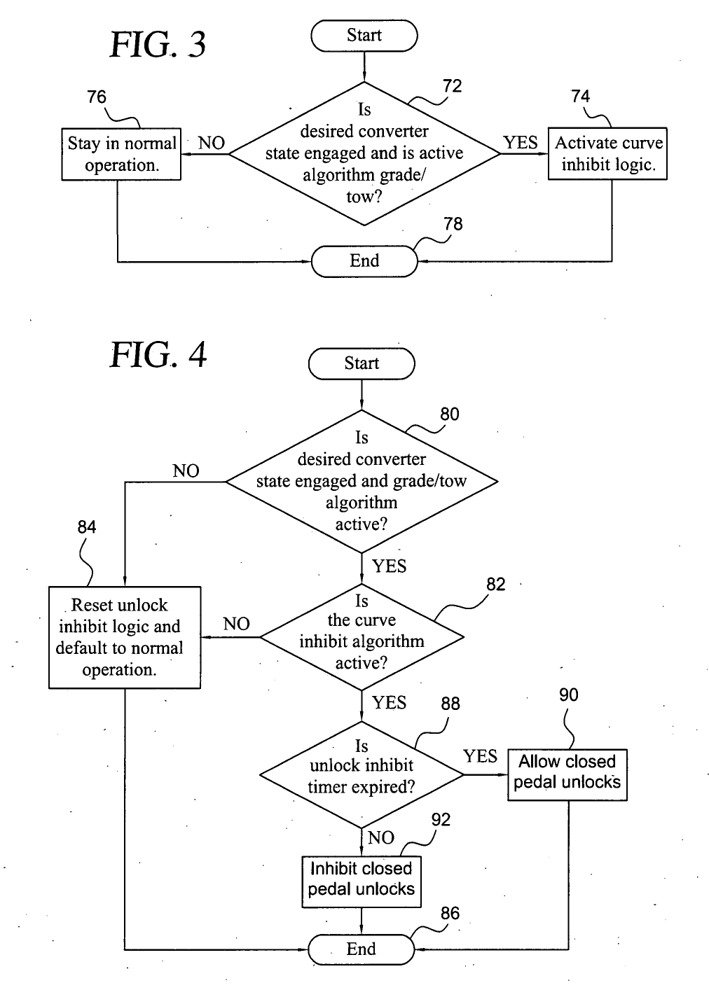

FIG. 3 illustrates steps of the shift scheduling algorithm 44 used by the PCM 14 to select between normal shift scheduling operation and a curve inhibit operation, which is a control strategy that maintains the converter clutch 60 in the engaged state when operation of the vehicle in a curve is detected. At step 72, a test is made to determine whether both the converter clutch 60 is in the engaged state and the grade/tow algorithm, is currently activated. If the test at 72 is logically true, a curve inhibit control algorithm is selected at 74 for execution by the PCM 14. But if test 72 is logically false, at step 76 shift scheduling remains in, or returns to normal operation, and the current execution the shift scheduling algorithm ends at 78.

The curve inhibit algorithm preferably determines whether a vehicle is operating in a curve with reference to a difference in speed of the wheels on a given axle, such as wheels 24, 25. The curve inhibit algorithm inhibits the gear shift by monitoring the current lateral acceleration rate by inferring that the vehicle is operating in a roadway curve. This is done by mathematical computations comparing the relative wheel speeds after informing the PCM 14 of known axle track dimensions. The system then decides whether to delay the shift event and converter clutch event based on comparison of current lateral acceleration to a reference vehicle lateral acceleration.

Lateral acceleration of the vehicle can be calculated using the wheel speeds at a reference axle from the following:

$$Lateral Acceleration = {( vehicle speed )}^{2} \frac{( 2 )}{( T )} \frac{( wheel speed 24 - wheel speed 25 )}{( wheel speed 24 + wheel speed 25 )}$$

wherein T is the track of the given axle, and each wheel speed is calculated from (rotational speed)*(rolling circumference of the wheel accounting for tire wear, tire pressure and wheel load). Examples of the magnitude of wheel track for two vehicles are front track 5.1151 and 5.2214 and rear track 5.1768 and 5.2313, respectively. If the vehicle is accelerating laterally, disengagement of the converter clutch 60 is prevented by the curve inhibit algorithm, provided vehicle speed is within a predetermined range, and the current transmission gear is in a predetermined range.

FIG. 4 illustrates a portion of the converter scheduling algorithm 42 that relates to control of the converter clutch 60 while the vehicle is loaded, ascending a steep grade or in a curve. At step 80, a test is made to determine whether both the converter clutch 60 is in the engaged state and the grade/tow algorithm, is currently activated. If the test at 80 is logically true, control advances to step 82. But if test 80 is logically false, indicating that the vehicle is not operating on a grade or loaded, control moves to step 84 where unlocking the torque converter clutch 60 can occur, i.e., a command 62 to maintain clutch 60 engaged is removed, control returns to normal shift scheduling, and the current execution of the algorithm ends at 86.

At step 82, a test is made to determine whether the curve inhibit algorithm is active. If test 82 is logically false, indicating that the vehicle is not operating on a curve, control moves to step 84 where unlocking the torque converter clutch 60 can occur, i.e., a command 62 to maintain clutch 60 engaged is removed, control returns to normal shift scheduling, and the current execution of the algorithm ends at 86. If the test at 82 is logically true, indicating that the vehicle is not operating in a curve, a test is made at 88 to determine whether a clutch-unlock inhibit timer is expired.

If the clutch-unlock inhibit timer is expired at 88, indicating expiration of period of predetermined length since issuing command 62 to inhibit unlocking clutch 60, closed pedal unlocking of the torque converter clutch 60 is permitted at 90, and the current execution of the algorithm ends at 86. Therefore, clutch 60 may be disengaged in response to the vehicle operator tipping out of accelerator pedal 26.

If the timer is not expired at 88, control passes to 92 where closed pedal unlocking of the torque converter clutch 60 is prevented until the clutch-unlock inhibit timer expires and the necessary conditions, shown in FIG. 4, are met. The current execution of the algorithm ends at 86.

Therefore, when the torque converter clutch 60 is engaged because the system detects a high vehicle load or a large grade, disengaging the converter clutch or allowing an upshift for a tip-out is delayed for a predetermined period. The delay is used to prevent aborting the inhibit mode for short term transient changes in the entry conditions.

In accordance with the provisions of the patent statutes, the preferred embodiment has been described. However, it should be noted that the alternate embodiments can be practiced otherwise than as specifically illustrated and described.

What is claimed is:

1. A method for controlling a torque converter clutch in an automatic transmission of a vehicle that includes an engine, an accelerator pedal and wheels, the converter clutch alternately connecting and disconnecting the engine and transmission when the clutch is engaged and disengaged, the method comprising the steps of:
(a) determining that the vehicle is either ascending a grade or operating in a loaded condition;
(b) determining that the clutch is engaged;
(c) determining whether the vehicle is operating in a curve;
(d) preventing disengagement of the clutch if the vehicle is either ascending a grade or operating in a loaded condition and the vehicle is operating in a curve;
(e) allowing disengagement of the clutch if the vehicle is neither ascending a grade nor operating in a loaded condition.

2. The method of claim 1, further comprising:
(f) monitoring movement of the accelerator pedal to determine the occurrence of a closed accelerator pedal; and
wherein step (d) further comprises preventing disengagement of the clutch if the accelerator pedal is closed.

3. The method of claim 1, further comprising:
(f) monitoring movement of accelerator pedal to determine the occurrence of a closed accelerator pedal; and
determining the length of a predetermined period that begins upon engaging the clutch; and
wherein step (e) further comprises allowing disengagement of the clutch if the accelerator pedal is closed and the predetermined period has expired.

4. The method of claim 1, wherein:
step (c) further comprises using a speed of the wheels at opposite lateral sides of an axle to determining a current vehicle lateral acceleration; and
step (d) further comprises:
determining a reference vehicle lateral acceleration; and
preventing disengagement of the clutch if the vehicle is either ascending a grade or operating in a loaded condition and if the vehicle lateral acceleration is greater than the reference vehicle lateral acceleration.

5. The method of claim 1, wherein:
step (c) further comprises determining a current vehicle lateral acceleration from
$${( VS )}^{2} \frac{( 2 )}{( T )} \frac{( wheel speed A - wheel speed B )}{( wheel speed A + wheel speed B )}$$
wherein VS is a speed of the vehicle, wheel speed A is a speed of a wheel at a first side of an axle, wheel speed B is a speed of a wheel at a second side of an axle opposite the first side, and T is a dimension of a track of the axle;
step (d) further comprises:
determining a reference vehicle lateral acceleration; and
preventing disengagement of the clutch if the vehicle is either ascending a grade or operating in a loaded condition and if the current vehicle lateral acceleration is greater than the reference vehicle lateral acceleration.

6. The method of claim 1, wherein:
step (c) further comprises using a speed of the wheels at opposite lateral sides of an axle to determining a current vehicle lateral acceleration; and
step (e) further comprises:
determining a reference vehicle lateral acceleration; and
allowing disengagement of the clutch if the vehicle is neither ascending a grade nor operating in a loaded condition and if the vehicle lateral acceleration is less than the reference lateral acceleration.

7. The method of claim 1, wherein:
step (c) further comprises determining a current vehicle lateral acceleration from
$${( VS )}^{2} \frac{( 2 )}{( T )} \frac{( wheel speed A - wheel speed B )}{( wheel speed A + wheel speed B )}$$
wherein VS is a speed of the vehicle, wheel speed A is a speed of a wheel at a first side of an axle, wheel speed B is a speed of a wheel at a second side of an axle opposite the first side, and T is a dimension of a track of the axle;
step (e) further comprises:
determining a reference vehicle lateral acceleration; and
allowing disengagement of the clutch if the vehicle is neither ascending a grade nor operating in a loaded condition and if the vehicle lateral acceleration is less than the reference lateral acceleration.

8. The method of claim 1, wherein step (a) further comprises:
determining a current position of the accelerator pedal;
determining a current vehicle acceleration;
determining a reference magnitude of vehicle acceleration that corresponds to the current position of the accelerator pedal;
comparing the current vehicle acceleration to the reference magnitude of vehicle acceleration that corresponds to the current position of the accelerator pedal; and
determining that the vehicle is either ascending a grade or operating in a loaded condition if the current vehicle acceleration is less than the reference magnitude of vehicle acceleration that corresponds to the current position of the accelerator pedal.

9. A system for controlling a torque converter in an automatic transmission of a vehicle that includes an engine and transmission, the system comprising:
a torque converter clutch alternately connecting and disconnecting the engine and transmission when the clutch is engaged and disengaged, respectively;
an accelerator pedal for at least partially controlling operation of the engine;
an accelerator pedal sensor producing a signal representing a position of the accelerator pedal;
a controller in communication with the transmission, the engine, the clutch, and the accelerator pedal sensor, the controller being configured to determine that the vehicle is either ascending a grade or operating in a loaded condition, determine that the clutch is engaged, determine whether the vehicle is operating in a curve, prevent disengagement of the clutch if the vehicle is either ascending a grade or operating in a loaded condition and the vehicle is operating in a curve, and allow disengagement of the clutch if the vehicle is neither ascending a grade nor operating in a loaded condition.

10. The system of claim 9, wherein the controller is further configured to monitor the signal produced by the accelerator pedal sensor to determine the occurrence of a closed accelerator pedal, and to prevent disengagement of the clutch if the accelerator pedal is closed.

11. The system of claim 9, further comprising:
a timer for measuring the length of a predetermined period that begins upon engaging of the clutch; and
wherein the controller is further configured to monitor the signal produced by the accelerator pedal sensor to determine the occurrence of a closed accelerator pedal, determine whether the timer is expired, and allow disengagement of the clutch if the accelerator pedal is closed and the timer is expired.

12. The system of claim 9, further comprising:
first and second wheels, each wheel located at an opposite lateral side of an axle; and
wherein the controller is further configured to use a speed of the first and second wheels to determine a current vehicle lateral acceleration, determine a reference vehicle lateral acceleration, and prevent disengagement of the clutch if the vehicle is either ascending a grade or operating in a loaded condition and if the vehicle lateral acceleration is greater than the reference vehicle lateral acceleration.

13. The system of claim 9, further comprising:
first and second wheels, each wheel located at an opposite lateral side of an axle; and
wherein the controller is further configured to determine a current vehicle lateral acceleration from
$${( VS )}^{2} \frac{( 2 )}{( T )} \frac{( wheel speed A - wheel speed B )}{( wheel speed A + wheel speed B )}$$
wherein VS is a speed of the vehicle, wheel speed A is a speed of the first wheel, wheel speed B is a speed of the second wheel, and T is a dimension of a track of the axle, determine a reference vehicle lateral acceleration, and prevent disengagement of the clutch if the vehicle is either ascending a grade or operating in a loaded condition and if the current vehicle lateral acceleration is greater than the reference vehicle lateral acceleration.

14. The system of claim 9, further comprising:
first and second wheels, each wheel located at an opposite lateral side of an axle; and
wherein the controller is further configured to determine a current vehicle lateral acceleration from
$${( VS )}^{2} \frac{( 2 )}{( T )} \frac{( wheel speed A - wheel speed B )}{( wheel speed A + wheel speed B )}$$
wherein VS is a speed of the vehicle, wheel speed A is a speed of the first wheel, wheel speed B is a speed of the second wheel, and T is a dimension of a track of the axle, determine a reference vehicle lateral acceleration, and allowing disengagement of the clutch if the vehicle is neither ascending a grade nor operating in a loaded condition and if the vehicle lateral acceleration is less than the reference lateral acceleration.

15. The system of claim 9, further comprising:
first and second wheels, each wheel located at an opposite lateral side of an axle; and
wherein the controller is further configured to use a speed of the first and second wheels to determine a reference vehicle lateral acceleration, and allow disengagement of the clutch if the vehicle is neither ascending a grade nor operating in a loaded condition and if the vehicle lateral acceleration is less than the reference lateral acceleration.

16. The system of claim 9, wherein the controller is further configured to determine a current position of the accelerator pedal, determine a current vehicle acceleration, determine a reference magnitude of vehicle acceleration that corresponds to the current position of the accelerator pedal, compare the current vehicle acceleration to the reference magnitude of vehicle acceleration that corresponds to the current position of the accelerator pedal, and determine that the vehicle is either ascending a grade or operating in a loaded condition if the current vehicle acceleration is less than the reference magnitude of vehicle acceleration that corresponds to the current position of the accelerator pedal.
